(19) United States
(12) Patent Application Publication
(10) Pub. No.: US 2014/0112777 A1
(43) Pub. Date: Apr. 24, 2014

(54) SYSTEM AND METHOD FOR MITIGATING WAKE LOSSES IN A WINDFARM

(71) Applicant: GENERAL ELECTRIC COMPANY, Schenectady, NY (US)

(72) Inventors: Chiranjeev Kalra, Glenville, NY (US); Stefan Kern, Munich (DE); Henk-Jan Kooijman, Enschede (NL)

(73) Assignee: GENERAL ELECTRIC COMPANY, Schenectady, NY (US)

(21) Appl. No.: 13/655,515

(22) Filed: Oct. 19, 2012

(51) Int. Cl. F03D 1/00

(52) U.S. Cl. 416/1; 416/120

(57) ABSTRACT

A system for mitigating wake losses in a windfarm is disclosed. The system may include a first horizontal axis wind turbine configured to rotate in a first direction and a second horizontal axis wind turbine positioned adjacent to the first horizontal axis wind turbine. The second horizontal axis wind turbine configured to rotate in a second direction, wherein the first direction is opposite the second direction.

### FIELD OF THE INVENTION

The present subject matter relates generally to wind turbines and, more particularly, to a system and method for mitigating wake losses for wind turbines located within a windfarm

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy from wind using known airfoil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

To maximize the overall energy production of wind turbines located within a windfarm, various considerations regarding the operation and/or the placement of the wind turbines must be taken into account. One such consideration is the impact of wakes created by upstream wind turbines on the performance of downstream wind turbines. In particular, upstream wind turbines produce a wake that is characterized by a region of increased wind turbulence and reduced velocity. These wake conditions generally result in higher fatigue loads and lower power capture for wind turbines positioned immediately downstream of the upstream wind turbines.

One solution for reducing the impact of wakes on downstream wind turbines is to increase the spacing between upstream and downstream wind turbines. This increased spacing allows for wake losses to be mitigated by allowing the wakes produced by upstream wind turbines to be sufficiently mixed with the ambient wind prior to hitting the downstream wind turbines. However, increased spacing between wind turbines also reduces the total amount of wind turbines that can be placed at a given wind turbine farm area, thereby reducing the overall potential energy production for the wind farm.

Accordingly, an improved system and method for reducing wake losses in a windfarm would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for mitigating wake losses in a windfarm. The system may include a first horizontal axis wind turbine configured to rotate in a first direction and a second horizontal axis wind turbine positioned adjacent to the first horizontal axis wind turbine. The second horizontal axis wind turbine configured to rotate in a second direction, wherein the first direction is opposite the second direction.

In another aspect, the present subject matter is directed to a windfarm including a first plurality of horizontal axis wind turbines disposed in a first row. The first plurality of horizontal axis wind turbines may be configured to rotate in a first direction. In addition, the windfarm may include a second plurality of horizontal axis wind turbines disposed in a second row located adjacent to the first row. The second plurality of horizontal axis wind turbines may be configured to rotate in a second direction, wherein the first direction is opposite the second direction.

In a further aspect, the present subject matter is directed to a method for mitigating wake losses in a windfarm. The method may include controlling the operation of a first horizontal axis wind turbine rotating in a first direction and controlling the operation of a second horizontal axis wind turbine rotating in a second direction, wherein the first direction is opposite to the second direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective, side view one embodiment of a wind turbine;

FIG. 2 illustrates a perspective view of one embodiment of a windfarm in accordance with aspects of the present subject matter, particularly illustrating the windfarm including counter-rotating wind turbines;

FIG. 3 illustrates a perspective view of an upstream wind turbine and a downstream wind turbine of the windfarm shown in FIG. 2, particularly illustrating the wake created by the upstream wind turbine;

FIG. 4 illustrates a cross-sectional view of a rotor blade of the upstream wind turbine shown in FIG. 3 taken about line 4-4; and

FIG. 5 illustrates a cross-sectional view of a rotor blade of the downstream wind turbine shown in FIG. 3 taken about line 5-5.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and method for mitigating wake losses in a windfarm. Specifically, the present subject matter is directed to a windfarm including alternating rows of counter-rotating wind turbines. For example, in several embodiments, the windfarm may include a first row of wind turbines configured to rotate in a first direction (e.g., in a clockwise direction) and a second row of wind turbines configured to rotate in a second direction (e.g., in a counter-clockwise direction). In such embodiments, the second row of wind turbines may be positioned immediately downstream of the first row of wind turbines. Thus, the upstream wind turbines positioned within the first row may create wakes that include rotational components in the first direction. Since the downstream wind turbines are configured to rotate in the opposite direction as the wakes, the effective wind speed for the downstream wind turbines may be increased as the wakes hit such turbines. This increase in the effective wind speed may generally improve the energy capturing capabilities of the downstream wind turbines, thereby reducing wake losses.

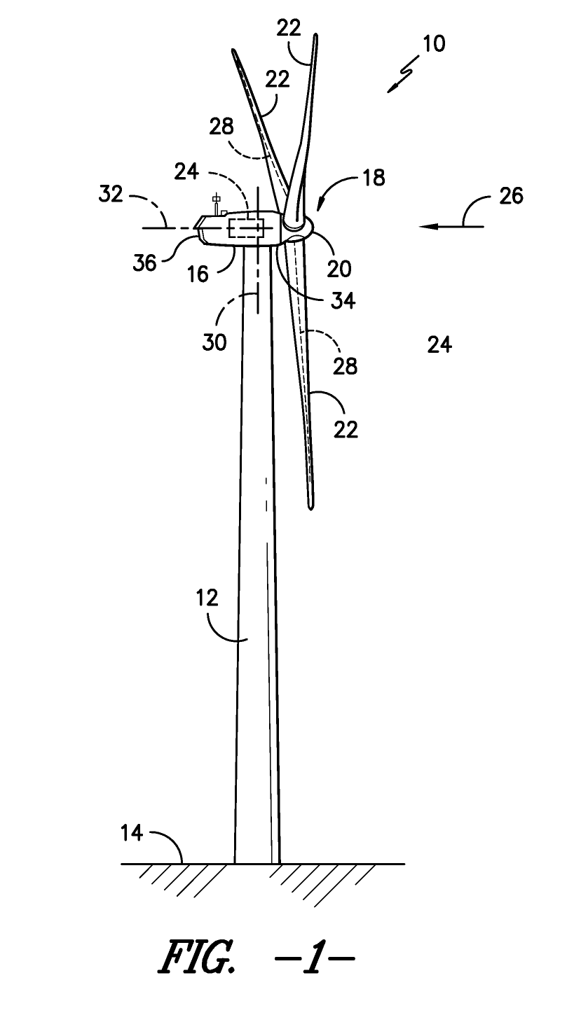

Referring now to the drawings, FIG. 1 illustrates perspective view of one embodiment of a wind turbine 10. As shown, the wind turbine 10 includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may generally be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator (not shown) positioned within the nacelle 16 to permit electrical energy to be produced.

In addition, the wind turbine 10 may also include a turbine control system or controller 24 centralized within the nacelle 16. However, it should be appreciated that the controller 24 may be disposed at any location on or in the wind turbine 10, at any location on the support surface 14 or generally at any other location. In general, the controller 24 may comprise a computer or other suitable processing unit. Thus, in several embodiments, the controller 24 may include suitable computer-readable instructions that, when implemented, configure the controller 24 to perform various different functions, such as receiving, transmitting and/or executing wind turbine control signals. As such, the controller 24 may generally be configured to control the various operating modes (e.g., start-up or shut-down sequences) and/or components of the wind turbine 10. For example, the controller 24 may be configured to control the blade pitch or pitch angle of each of the rotor blades 22 (i.e., an angle that determines a perspective of the rotor blades 22 with respect to the direction 26 of the wind) to control the loading on the rotor blades 22 and/or the power output generated by the wind turbine 10 by adjusting an angular position of at least one rotor blade 22 relative to the wind. For instance, the turbine controller 24 may control the pitch angle of the rotor blades 22, either individually or simultaneously, by transmitting suitable control signals/commands to a pitch controller (not shown) of the wind turbine 10, which may be configured to control the operation of a plurality of pitch drives (not shown) of the wind turbine 10. Specifically, the rotor blades 22 may be rotatably mounted to the hub 20 by one or more pitch bearing(s) (not shown) such that the pitch angle may be adjusted by rotating the rotor blades 22 along their pitch axes 28 using the pitch adjustment mechanisms. Further, as the direction 26 of the wind changes, the turbine controller 24 may be configured to control a yaw direction of the nacelle 16 about a yaw axis 30 to position the rotor blades 22 with respect to the direction 26 of the wind, thereby controlling the loads acting on the wind turbine 10. For example, the turbine controller 24 may be configured to transmit control signals/commands to a yaw drive mechanism (not shown) of the wind turbine 10 such that the nacelle 16 may be rotated about the yaw axis 30.

As shown, the wind turbine 10 is configured as a horizontal axis wind turbine. Thus, the rotor blades 22 may generally be configured to rotate about a rotational axis 32 extending generally parallel to the ground and generally perpendicular to the tower 12. Additionally, the nacelle 16 may generally be configured to extend lengthwise along the rotational axis 32 between an upwind side 34 and a downwind side 36. In several embodiments, as shown in FIG. 1, the rotor 18 for the wind turbine 10 may be configured to be positioned on the upwind side 34 of the nacelle 16. For instance, as described above, the controller 24 may be configured to control the yaw drive mechanism of the wind turbine 10 such that the nacelle 16 is rotated about the yaw axis 30 in a manner that maintains the upwind side 34 of the nacelle 16 facing the direction 26 of the wind. However, in other embodiments, the rotor 18 may be configured to be positioned on the downwind side 36 of the nacelle 16.

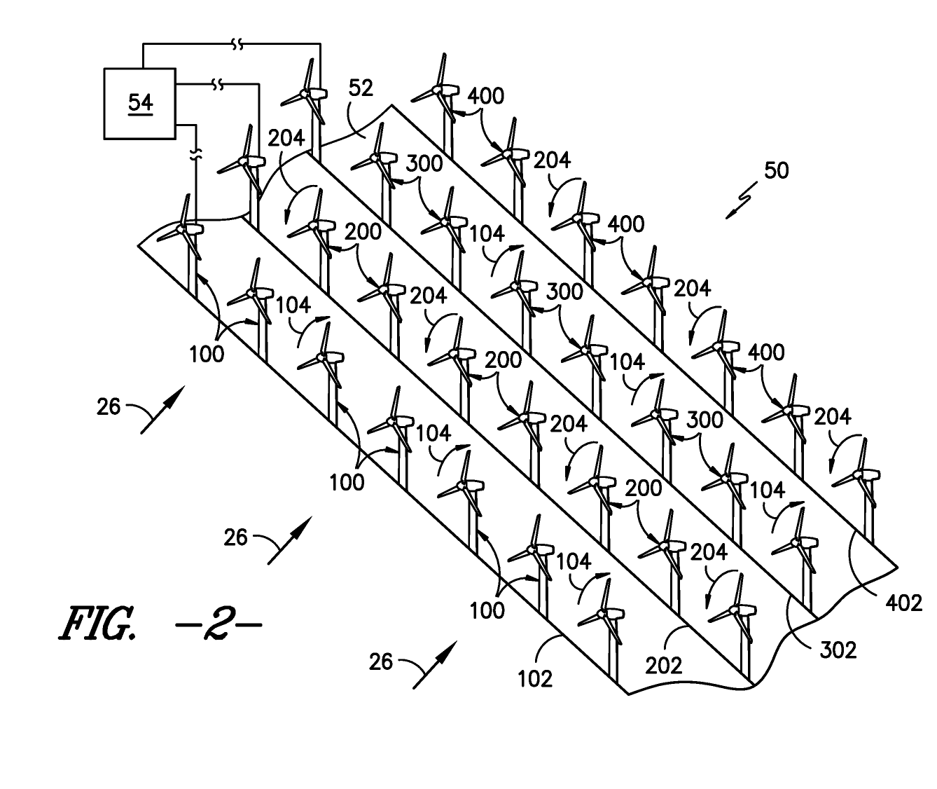

Referring now to FIG. 2, a perspective view of one embodiment of a windfarm 50 is illustrated in accordance with aspects of the present subject matter. As shown, the windfarm 50 may include a plurality wind turbines 100, 200, 300, 400 spaced apart from one another at a windfarm site 52. In general, each wind turbine 100, 200, 300, 400 may be configured the same as or similar to the wind turbine 10 described above with reference to FIG. 1. Thus, in several embodiments, each wind turbine 100, 200, 300, 400 may be configured as a horizontal axis wind turbine and may include a tower 12, a nacelle 16 and a rotor 18 (including a rotatable hub 20 and at least one rotor blade 22 extending from the rotatable hub 20), as well as any of the other components of the wind turbine 10 described above and/or any other suitable wind turbine components known in the art.

In several embodiments, the wind turbines 100, 200, 300, 400 may be arranged in separate rows spaced apart across the windfarm site 52. For example, in the illustrated embodiment, the windfarm 50 may include a first set of wind turbines 100 aligned in a first row 102, a second set of wind turbines 200 aligned in a second row 202, a third set of wind turbines 300 aligned in a third row 302 and a fourth set of wind turbines 400 aligned in a fourth row 402. It should be appreciated that the particular number of wind turbine rows 102, 202, 302, 402 shown in the illustrated embodiment is simply provided for illustrative purposes and, thus, the windfarm 50 may generally include any number of rows, such as less than four wind turbine rows and/or greater than four wind turbines. Similarly, it should be appreciated that any number of wind turbines 100, 200, 300, 400 may be disposed in each wind turbine row.

In several embodiments, the wind turbine rows 102, 202, 302, 403 may generally be configured to extend lengthwise perpendicularly to the direction of the prevailing or dominant wind. For example, as shown in FIG. 2, the direction 26 of the wind extends generally transverse to the wind turbine rows 102, 202, 302, 403 from the lower left to the upper right such that the second row 202 is downstream from the first row 102 and upstream from the third row 302. However, in alternative embodiments, the wind turbine rows 102, 202, 302, 402 may have any other suitable orientation relative to the direction 26 of the wind.

Additionally, as described above, in several embodiments, the rotors 18 of the wind turbines 100, 200, 300, 400 in each row 102, 202, 302, 402 may be configured to rotate in an opposite direction from the wind turbines in adjacent rows such that the windfarm 50 includes alternating rows of counter-rotating wind turbines. For example, as shown in FIG. 2, the rotors 18 of the wind turbines 100, 300 in the first and third rows 102, 302 may be configured to rotate in a first direction (indicated by arrows 104) while the rotors 18 of the wind turbines 200, 400 in the second and fourth rows 202, 402 may be configured to rotate in a section direction (indicated by arrows 204). Thus, each row of downstream wind turbines (e.g., the wind turbines 200, 300, 400 in the second, third and fourth rows 202, 302, 402) may include rotors 18 rotating in an opposite direction from the rotors 18 of the wind turbines in the immediately upstream row.

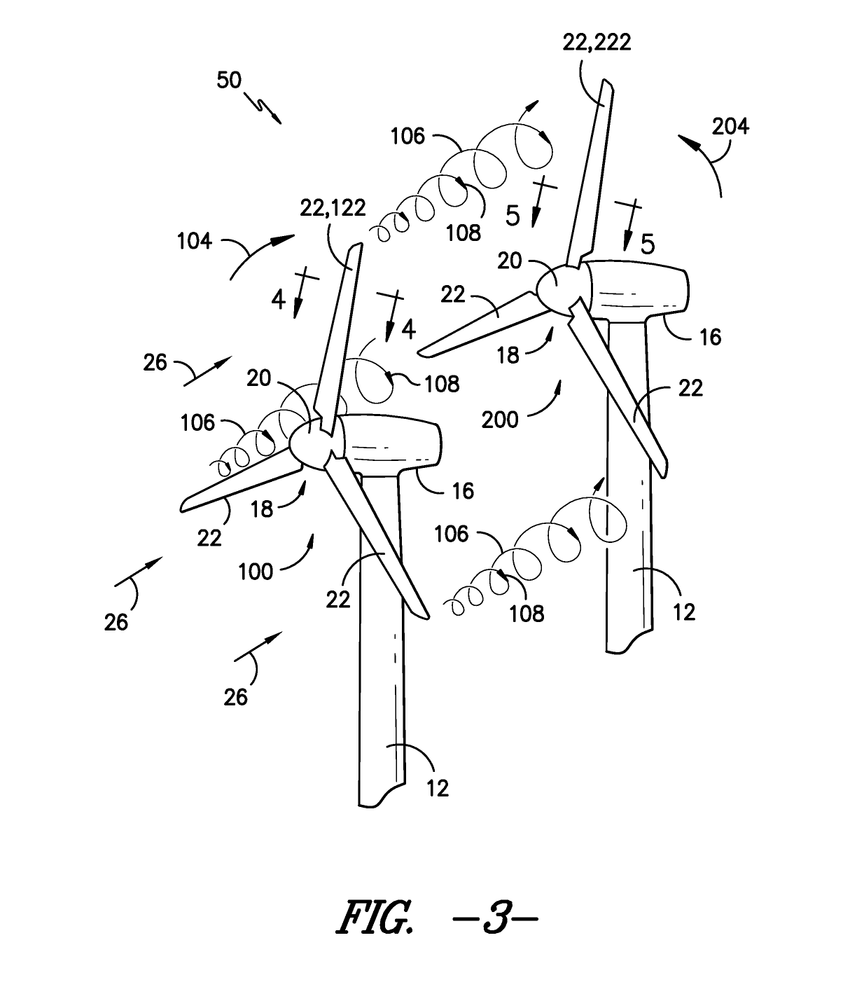

By alternating the direction of rotation of the wind turbine rotors 18 between each row 102, 202, 302, 402, the wake losses typically occurring for the downstream wind turbines may be reduced, thereby increasing the overall efficiency of the windfarm 50. For example, FIG. 3 illustrates adjacent wind turbines 100, 200 from the first and second rows 102, 202 of the windfarm 50 described above. As shown, the rotor 18 of the upstream wind turbine 100 is configured to rotate in the first direction 104 while the rotor 18 of the downstream wind turbine 200 is configured to rotate in the second direction 204. Thus, the upstream wind turbine 100 may generally create wakes 106 in the wind flow that have a rotational component in the first direction (indicated by the arrows 108). Accordingly, as the wakes 106 flow towards the downstream wind turbine 200, the difference in rotation between the wakes 106 and the downstream rotor 18 may generally result in an increase in the effective wind speed hitting the downstream wind turbine 200, thereby reducing the amount of the wake losses that would otherwise result in the event that the downstream rotor 18 was rotating in the same direction as the wakes 106.

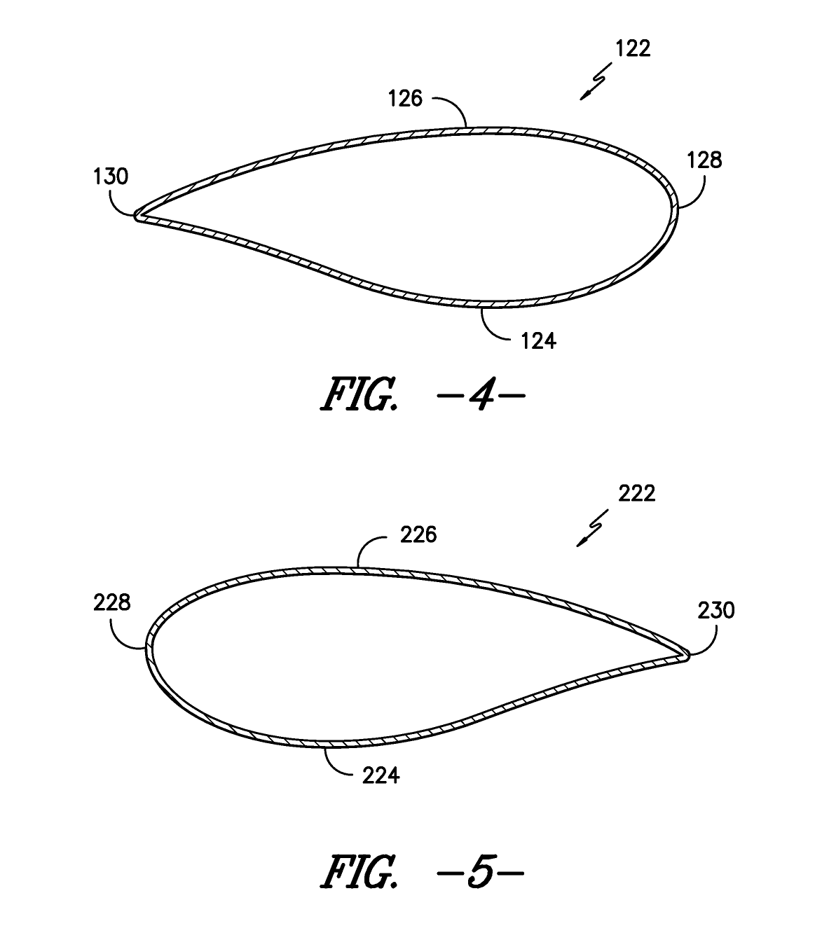

Additionally, it should be appreciated that the rotor blades 22 of the wind turbines 100, 300 rotating in the first direction 104 may have a different aerodynamic configuration than the rotor blades 22 of the wind turbines 200, 400 rotating in the second direction 204. Specifically, in several embodiments, the rotor blades 22 of the wind turbines 100, 300 disposed in the first and third rows 102, 302 may have an inverse or mirrored configuration relative to the rotor blades 22 of the wind turbines 200, 400 disposed in the second and fourth rows 202, 402. For example, FIG. 4 illustrates a cross-sectional view of a first rotor blade 122 from the upstream wind turbine 100 shown in FIG. 3, particularly illustrating the orientation of the first rotor blade 122 at a zero degree or twelve o′clock rotor position (i.e., wherein the rotor blade 122 is extending upward perpendicular to the ground). As shown, the first rotor blade 122 includes a pressure side 124 and a suction side 126 extending between a leading edge 128 and a trailing edge 130. Similarly, FIG. 5 illustrates a cross-sectional view of a second rotor blade 222 from the downstream wind turbine 200 shown in FIG. 3, particularly illustrating the orientation of the second rotor blade 222 at the zero degree or twelve o′clock rotor position. As shown, the second rotor blade 222 also includes a pressure side 224 and a suction side 226 extending between a leading edge 228 and a trailing edge 230. However, the second rotor blade 222 has a mirrored configuration relative to the first rotor blade 122. As such, the first rotor blade 122 may be configured to effectively capture energy from the wind when rotated in the first direction 106 and the second rotor blade 222 may be configured to effectively capture energy from the wind when rotated in the second direction 206.

As described above, it should be appreciated that the present subject matter is also directed to a method for mitigating wake losses in a windfarm 50. In one embodiment, the method may generally include controlling the operation of a first horizontal axis wind turbine (e.g., wind turbine 100) rotating in a first direction 104 and controlling the operation of a second horizontal axis wind turbine (e.g., wind turbine 200) rotating in a second direction 106. Such control of the operation of the wind turbines may be provided, as indicated above, by the individual controllers 24 of each wind turbine. Alternatively, the windfarm 50 may include a farm controller 54 communicatively coupled to each of the individual controllers 24 of the wind turbines. As such, the farm controller 54 may be configured to issue control commands to all of the wind turbines (or groups of the wind turbines) located within the windfarm 50 in order to control their operation.

It should also be appreciated that, in addition to configuring the wind turbines 100, 200, 300, 400 to rotate in a direction that is opposite to the direction of rotation of upstream and downstream wind turbines positioned in adjacent rows or as an alternative thereto, each wind turbine 100, 200, 300, 400 may be configured to rotate in an opposite direction relative to adjacent wind turbines positioned in the same row. For example, as described above with reference to FIG. 2, a given wind turbine 200 positioned in the second row 202 may be configured to rotate in a direction (e.g., the second direction 204) that is opposite from the direction of rotation (e.g., the first direction 104) of the upstream wind turbine 100 positioned in the first row 102 and the downstream wind turbine 100 positioned in the third row 302. In addition to such counter-rotating wind turbines or as an alternative thereto, the wind turbines 200 positioned adjacent to a given wind turbine 200 positioned in the second row 102 may be configured to rotate in a direction (e.g., the first direction 204) that is opposite from the direction of rotation (e.g., the second direction 104) of the given wind turbine 200. In such an embodiment, each row 102, 202, 302, 402 may include alternating, counter-rotating wind turbines 100, 200, 300, 400 such that each wind turbine 100, 200, 300, 400 within the wind farm 50 rotates in an opposite direction relative to the wind turbines positioned adjacent to such wind turbine (e.g., relative to the wind turbines positioned to the left, right, upstream and downstream of a given wind turbine).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for mitigating wake losses in a windfarm, the system comprising:
a first horizontal axis wind turbine configured to rotate in a first direction; and
a second horizontal axis wind turbine positioned adjacent to the first horizontal axis wind turbine, the second horizontal axis wind turbine configured to rotate in a second direction,
wherein the first direction is opposite the second direction.

2. The system of claim 1, wherein the first and second horizontal axis wind turbines each include at least one rotor blade, the at least one rotor blade for the first horizontal axis wind turbine having an mirrored configuration relative to the at least one rotor blade for the second horizontal axis wind turbine.

3. The system of claim 1, wherein the first and second horizontal axis wind turbines each include a rotor and a nacelle, the rotor being disposed on an upwind side of the nacelle.

4. The system of claim 1, further comprising a third horizontal axis wind turbine disposed adjacent to the second horizontal axis wind turbine, the third horizontal axis wind turbine configured to rotate in the first direction.

5. The system of claim 4, wherein the first, second and third horizontal axis wind turbines each include at least one rotor blade, the at least one rotor blade for the first and third horizontal axis wind turbines having an mirrored configuration relative to the at least one rotor able for the second horizontal axis wind turbine.

6. The system of claim 1, wherein the first horizontal axis wind turbine is disposed within a first row of the windfarm and the second horizontal axis wind turbine is disposed within a second row of the windfarm, the first row including a plurality of horizontal axis wind turbines configured to rotate in the first direction and the second row including a plurality of horizontal axis wind turbines configured to rotate in the second direction, the second row being disposed downstream of the first row.

7. A windfarm comprising:
a first plurality of horizontal axis wind turbines aligned in a first row, the first plurality of horizontal axis wind turbines configured to rotate in a first direction; and
a second plurality of horizontal axis wind turbines aligned in a second row position adjacent to the first row, the second plurality of horizontal axis wind turbines configured to rotate in a second direction,
wherein the first direction is opposite the second direction.

8. The system of claim 7, wherein each horizontal axis wind turbine includes at least one rotor blade, the at least one rotor blade for each of the first plurality of horizontal axis wind turbines having a mirrored configuration relative to the at least one rotor blade for each of the second plurality of horizontal axis wind turbines.

9. The windfarm of claim 8, wherein the first and second rows extend generally perpendicular to a direction of the wind.

10. The windfarm of claim 8, wherein each horizontal axis wind turbine includes a rotor and a nacelle, the rotor being disposed on an upwind side of the nacelle.

11. The windfarm of claim 8, further comprising a third plurality horizontal axis wind turbines aligned in a third row adjacent to the second row, the third plurality of horizontal axis wind turbines configured to rotate in the first direction.

12. The windfarm of claim 11, wherein the second row is disposed between the first and third rows.

13. The windfarm of claim 11, wherein each horizontal axis wind turbine includes at least one rotor blade, the at least one rotor blade for each of the first plurality of horizontal axis wind turbines and the third plurality of horizontal axis wind turbines having an mirrored configuration relative to the at least one rotor able for each of the second plurality of horizontal axis wind turbines.

14. A method for mitigating wake losses in a windfarm, the method comprising:
controlling the operation of a first horizontal axis wind turbine rotating in a first direction; and
controlling the operation of a second horizontal axis wind turbine rotating in a second direction, the second horizontal axis wind turbine being positioned adjacent to the first horizontal axis wind turbine, wherein the first direction is opposite the second direction.

15. The method of claim 14, wherein the first and second horizontal axis wind turbines each include at least one rotor blade, the at least one rotor blade for the first horizontal axis wind turbine having an mirrored configuration relative to the at least one rotor blade for the second horizontal axis wind turbine.

16. The method of claim 14, wherein the first and second horizontal axis wind turbines each include a rotor and a nacelle, the rotor being disposed on an upwind side of the nacelle.

17. The method of claim 14, further comprising controlling the operation of a third horizontal axis wind turbine rotating in the first direction, the third horizontal axis wind turbine being positioned adjacent to the second horizontal axis wind turbine.

18. The method of claim 14, wherein the first horizontal axis wind turbine is disposed within a first row of the windfarm, the first row including a plurality of horizontal axis wind turbines configured to rotate in the first direction.

19. The method of claim 18, wherein the second horizontal axis wind turbine is disposed within a second row of the windfarm, the second row including a plurality of horizontal axis wind turbines configured to rotate in the second direction.

20. The method of claim 19, wherein the first and second rows extend generally perpendicular to a direction of the wind, the second row being downstream from the first row.
